(19) United States
(12) Patent Application Publication
(10) Pub. No.: US 2016/0255181 A1
(43) Pub. Date: Sep. 1, 2016

(54) METHOD AND SYSTEM FOR PROVIDING SELECTIVE CALL EXECUTION BASED ON USER PREFERENCES

(71) Applicant: VONAGE NETWORK LLC, Holmdel, NJ (US)

(72) Inventors: Natan Shaltiel, Tel-Aviv (IL); Dana Almagor, Tel-Aviv (IL); Guy Bar On, Tel-Aviv (IL); Lihi Gendelis, Tel Aviv-Yafo (IL)

(21) Appl. No.: 14/632,431

(22) Filed: Feb. 26, 2015

(51) Int. Cl. H04M 1/00; H04L 29/06

(52) U.S. Cl. CPC H04M 1/006; H04L 65/40

(57) ABSTRACT

A method and apparatus for providing selective call execution based on user preferences in a user communication device are provided herein. The method includes intercepting an outgoing call placed using a native telecommunication dialer; and diverting the intercepted call to an OTT telecommunication application based on a comparison of information associated with the intercepted call and one or more pre-selected user preferences for diverting calls to the OTT telecommunication application.

### BACKGROUND

1. Field

Embodiments of the present invention generally relate to methods and systems for providing selective call execution based on user preferences.

2. Description of the Related Art

When a mobile device user places a telephone call, he or she often uses a native telephone dialer on his or her mobile device to place the call. However, there may be more cost effective ways of placing the call, for example using an over-the-top (OTT) mobile telephony application, such as a Voice over Internet Protocol (VoIP) app. This is particularly true when calling internationally or when roaming in which case prices could vary greatly between calling methods. Other network conditions may also influence the manner in which a call is placed, for example, a user may wish to use an available wireless local area network (WLAN), for example a WLAN based on the Institute of Electrical and Electronics Engineers' (IEEE) 802.11 and 802.13 standards, during poor cellular reception to place the call. Currently, in order for a user to place a call, the user needs to actively choose the method of calling, using either the native telephony application or instead open a specific mobile telephony application. In order to make such a decision, the user needs to factor in the various parameters discussed above and disregard the convenience of simply using the native telephony application for call initiation. However, the user may not have all the information to determine the most efficient and cheapest way to make the call. It would be beneficial to a user to be able to pre-select under what circumstances a call should be diverted to the mobile telephony application rather than the native telephone application on his or her mobile device.

Therefore, there exists a need in the art for a method and system for providing selective call execution based on user preferences.

### SUMMARY

A method and system for providing selective call execution based on user preferences in a user communication device are provided herein. In some embodiments, a method for providing selective call execution based on user preferences may include intercepting an outgoing call placed using a native telecommunication dialer of the user communication device; and diverting the intercepted call to an over-the-top (OTT) telecommunication application based on a comparison of information associated with the intercepted call and one or more pre-selected user preferences for diverting calls to the OTT telecommunication application.

In some embodiments, a system for providing selective call execution based on user preferences in a user communication device may include a routing configuration module configured to receive and store user preferences for intercepting an outgoing call placed using a native telecommunication dialer of the user communication device and diverting the intercepted call to an over-the-top (OTT) telecommunication application based on a comparison of information associated with the intercepted call and one or more pre-selected user preferences for diverting calls to the OTT telecommunication application; and a call-intercept module configured to intercept an outgoing call placed using a native telecommunication dialer.

In some embodiments, a non-transitory computer readable medium for providing selective call execution based on user preferences is provided. The computer readable medium stores computer instructions that, when executed by at least one processor causes the at least one processor to perform the method for providing selective call execution based on user preferences.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for providing selective call execution based on user preferences, according to one or more embodiments;

FIG. 3 illustrates a graphical user interface for providing selective call execution based on user preferences, according to one or more embodiments;

FIG. 4 depicts a flow diagram of a method for providing selective call execution based on user preferences, according to one or more embodiments of the invention;

FIG. 5 depicts a computer system that can be utilized in various embodiments of the present invention to implement the computer and/or the display, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and apparatus for providing selective call execution based on user preferences. In some embodiments, a user may configure user preferences for when a mobile telephony application, such as a VoIP app, will intercept outgoing native calls and instead place those calls using the mobile telephony application's calling method. Examples of configurable user preferences include, but are not limited to routing through the mobile telephony application any outgoing calls made to a specific number or contact, routing calls if the number is an international number, routing calls if the mobile device is at a specific location or connected to a specific wireless access point, routing calls if roaming charges apply and data is enabled, routing calls using the lowest rate plan for the location and time of the call being made, and the like. When an outgoing call is placed using the native telephone application, the mobile telephony application intercepts the call in order to determine whether the outgoing call, or information associated with the outgoing call, corresponds to any of the configured user preferences, and if so, diverts the call to the mobile telephony application. If the intercepted call, or information associated with the intercepted call, does not correspond to any of the user preferences, the call is released back to the native dialer for call initiation. However, when the call is complete, the user may be prompted to configure a user preference that would apply to future calls.

Although the present disclosure discusses intercepting outgoing calls made using a native telecommunication module, one skilled in the art will appreciate that other communications, such as text messages, may be intercepted and diverted to the mobile telephony application based on pre-set user preferences.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any native application may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

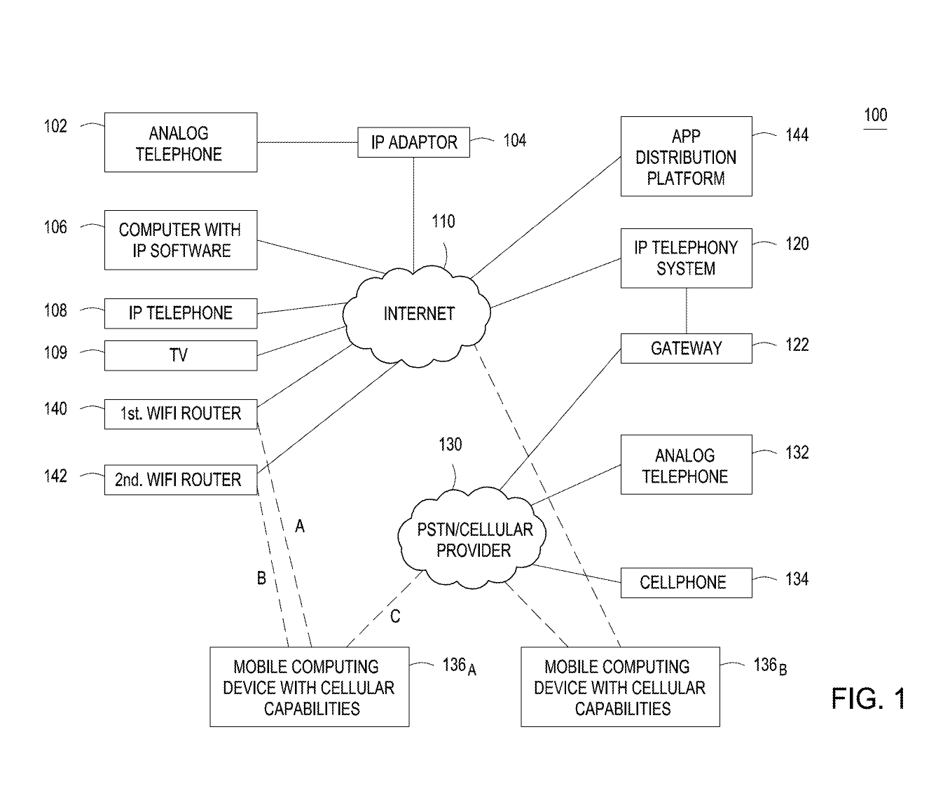

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136_{A} (e.g., a smartphone) is capable of establishing a first wireless data connection A with a first wireless access point 140, such as a wireless local area network (WLAN) based on the Institute of Electrical and Electronics Engineers' (IEEE) 802.11 and 802.13 standards router. The first wireless access point 140 is coupled to the Internet 110. Thus, the mobile computing device 136_{A} can establish a VOIP telephone call with the IP telephony system 120 via a path through the Internet 110 and the first wireless access point 140.

FIG. 1 also illustrates that the mobile computing device 136_{A} can establish a second wireless data connection B with a second wireless access point 142 that is also coupled to the Internet 110. Further, the mobile computing device 136_{A} can establish either a third wireless data connection C via a packet-switched network provided by a cellular service provider 130 using its cellular telephone capabilities, or establish a voice based session telephone call via a circuit-switched network provided by a cellular service provider 130. The mobile computing device 136_{A} could also establish a VoIP telephone call with the IP telephony system 120 via the second wireless connection B or the third wireless connection C.

Although not illustrated in FIG. 1, the mobile computing device 136_{A} may be capable of establishing a wireless data connection to a data network, such as the Internet 110, via alternate means. For example, the mobile computing device 136_{A} might link to some other type of wireless interface using an alternate communication protocol, such as the wireless local area network (WLAN) based on the Institute of Electrical and Electronics Engineers' (IEEE) 802.11 and 802.13 standards.

Similarly, mobile computing device with cellular capabilities 136_{B} may also be coupled to internet 110 and/or cellular service provider 130. In some embodiments, mobile computing device 136_{B} may be connected to internet 110 via a wireless local area network (WLAN) based on the Institute of Electrical and Electronics Engineers' (IEEE) 802.11 and 802.13 standards connection, and the like, and can also establish a VOIP telephone call with the IP telephony system 120 similar to mobile computing device 136_{A}. In embodiments of the present invention, communications environment 100 may be used to establish voice based or data based telecommunications sessions between mobile computing device 136_{A} and mobile computing device 136_{B}, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136_{A} may download a VOIP mobile app from app distribution platform 144 and install the VOIP mobile app locally making the app a native application running on mobile computing device 136_{A}.

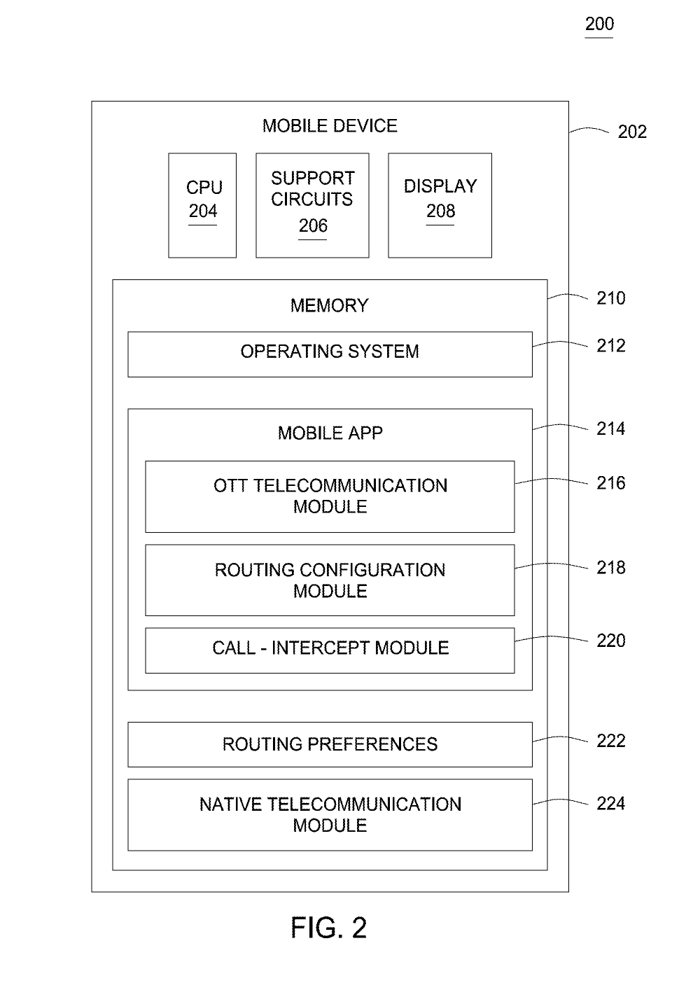

FIG. 2 illustrates some of the elements that are present in a mobile device 202, according to one or more embodiments of the present invention. The mobile device 202 may include a computer with IP software 106, IP telephone 108, and/or mobile computing device with cellular capabilities 136A, 136B, and the like, as shown in FIG. 1.

The mobile device 202 comprises a Central Processing Unit (CPU) 204, support circuits 206, display 208, and a memory 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output circuits, and the like. The memory 210 comprises at least one of Read Only Memory (ROM), Random Access Memory (RAM), disk drive storage, optical storage, removable storage and/or the like. In some embodiments, the memory 210 comprises an operating system 212, a mobile application 214, routing preferences 222, and a native telecommunication module 224, including a native dialer. The mobile application 214 includes an over-the-top (OTT) telecommunication module 216, a routing configuration module 218, and a call-intercept module 220. The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, LINUX, MAC OSX, BSD, UNIX, MICROSOFT WINDOWS, 10S, ANDROID and the like.

In some embodiments, the mobile app 214 may be a mobile VoIP app that provides VoIP telephony services to an end-user. For example, in some embodiments, mobile app 214 may be a mobile extension application installed on mobile device 202. In some embodiments, an end-user may download the mobile app 214 from IP telephony system 120, or from an app distribution system 144, and install the mobile app 214 on their device.

The native telecommunication module 224 may be used to facilitate, and otherwise provide, communication services such as, for example, GSM voice calling, CDMA voice calling, or various other types of communication services provided by a PSTN/Cellular service provider 130 (e.g., using traditional mobile phone mobile communication technology standards).

A user may pre-set preferences such that outgoing native calls, or rather, information about the outgoing calls, that correspond to the pre-set user preferences are intercepted and instead executed by the over-the-top (OTT) telecommunication module 216. A list of configurable options is presented to the user of mobile device 202 on display 208. For example, the user may select one or more telephone numbers or contacts, such that when calling said telephone number or contact execute the call by the OTT telecommunication module 216. The phone number of the outgoing call is compared to the selected one or more telephone numbers or contacts. If there is a match, the call is executed by the OTT telecommunications module 216. More generally, the user may select that all international calls be executed by the OTT telecommunication module 216. From the phone number of the outgoing call, the country code is used to determine whether the call is a local call or a long distance (i.e., international) call. If the call is a long distance call, it is executed by the OTT telecommunications module 216. The user may select that a call be executed by the OTT telecommunications module 216 based on the strength of the wireless network signal versus the cellular signal. The wireless strength and cellular strength may be determined, for example, via an application programming interface (API) provided by the operating system 212. If the wireless strength is stronger than the cellular signal strength, the call is executed by the OTT telecommunications module 216. The user may predefine a number of minutes of calls that may be placed using the native dialer and if that number of minutes is exceeded, the call is executed by the OTT telecommunication module 216. The list of configurable options may be dynamic and selection of the options may be modified or disabled at any time. The selected configurable options are stored as routing preferences 222.

When a user initiates an outgoing call using a native dialer as part of the native telecommunication module 224, the call-intercept module 220 intercepts the outgoing call. The call-intercept module 220 accesses the routing preferences 222. If the outgoing call corresponds to the criteria of one of the selected routing preferences, the call is initiated using the OTT telecommunication module 216. If the outgoing call does not correspond to the criteria for any routing preference listing 222 that would execute the call by the OTT telecommunication module 216, the call is released to the native telecommunication module 224. In other words, the outgoing call is initiated from the native telecommunication module 224. In some embodiments, upon completion of the call, the routing configuration module 218 prompts the user to review the routing preferences. The list of configurable options is presented to the user of mobile device 202 on display 208, with the option that applies to the outgoing call pre-set as a suggestion. For example, if the outgoing call was an international call and the user does not have international calls executed by the OTT telecommunication module 216, the list of configurable options may be displayed with the option of, for example, “execute all international or long-distance calls using the mobile app” pre-selected. The user may opt to save the selection as a routing preference 222.

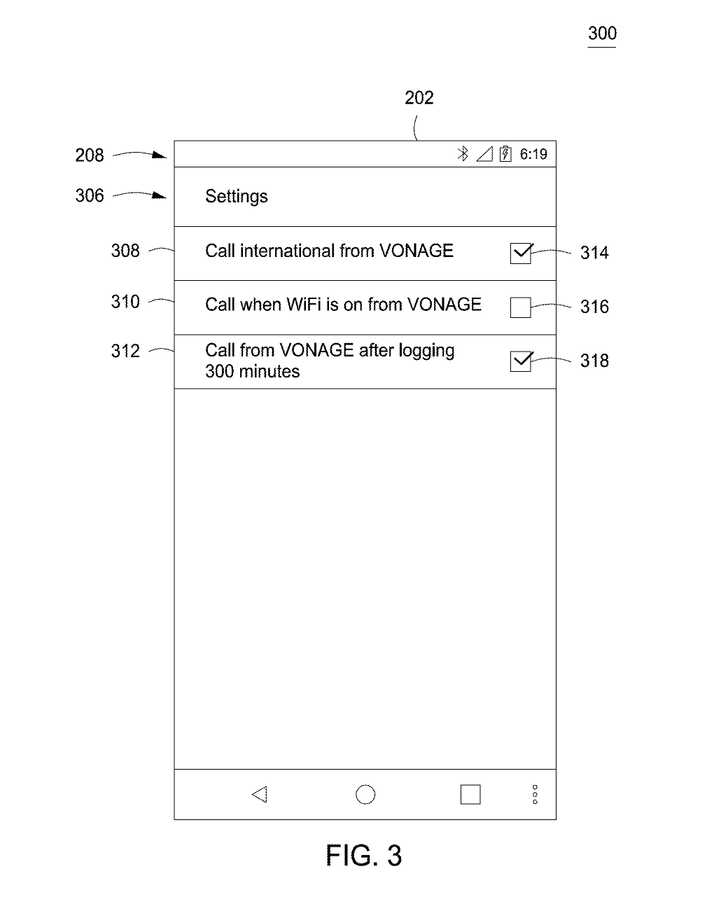

FIG. 3 illustrates a graphical user interface 300 for providing selective call execution based on user preferences, according to one or more embodiments. A list of configurable options 308, 310, 312 is presented to the user of mobile device 202 on display 208. The configurable options 308, 310, and 312 are merely illustrative and not meant to be an exhaustive list of options. On display 208, a setting screen 306 is displayed for the user. Option Indicator Boxes 314, 316, and 318 may be selected in order to enable a call to be executed by the OTT telecommunication module 216. In the present example, by checking box 314, the user has selected to have all international calls executed by VONAGE (i.e., OTT telecommunication module 216). In addition, by checking box 318, the user has selected to have all calls executed by VONAGE (i.e., OTT telecommunication module 216) after the user has logged 300 minutes using the native telecommunications module 224. Additional options, not shown, may include “SELECT ALL”, or “DESELECT ALL”, and the like. All selected options are saved as routing preferences 222.

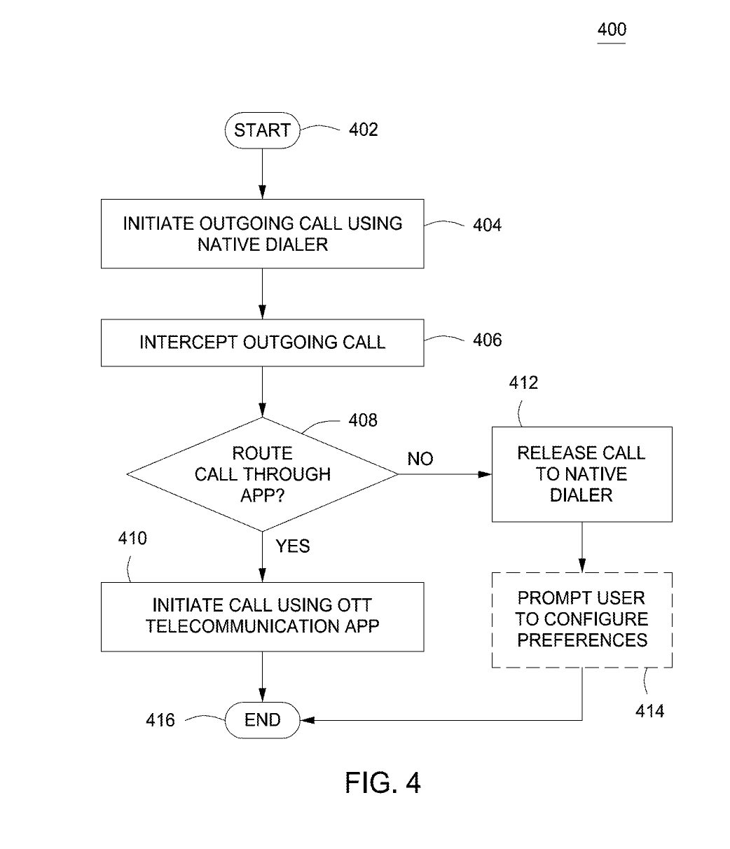

FIG. 4 depicts a flow diagram of a method 400 for providing selective call execution based on user preferences, according to one or more embodiments of the invention. The method 400 starts at step 402 and proceeds to step 404.

At step 404, an outgoing call is initiated using a native dialer provided by the native telecommunication module 224. At step 406, the outgoing call is intercepted by the call-intercept module 220. The call-intercept module may create an outgoing call interceptor that listens for an outgoing call from the native telecommunication module.

At step 408, it is determined whether the call should be executed by the OTT telecommunication module 216. Each selected call execution preference 222 is analyzed to determine whether criteria is met that diverts the call such that the call is executed by the OTT telecommunication module 216. For example, if the routing preference states that all international calls are to be executed by the OTT telecommunication module, the telephone number of the outgoing call is extracted and a determination is made whether the telephone number is an international call. If the routing preference states that all calls should be executed by the OTT telecommunication module 216 after 300 minutes have been logged using the native telecommunication module, then a number of used minutes is identified and the determination is made whether the minutes exceed that specified in the routing preference.

If it determined that the call should be diverted to the OTT telecommunication module, at step 410, the call is initiated using the OTT telecommunication module and the method 400 ends at step 416. However, if at step 408, it is determined based on the routing preferences, that the call should not be diverted to the OTT telecommunication module, at step 412, the outgoing call is released back to the native telecommunication module, where the call may be initiated using the native dialer.

Optionally at step 414, the user is prompted to configure user preferences for the call that was released back to the native dialer. When the call is ended, the graphical user interface is displayed as shown in FIG. 3 above. However, a configuration option that may have applied to the call is pre-selected as a suggestion to the user. For example, if a wireless access point was available such that the call could have been executed using the OTT telecommunication module, the option 310 “Call when WIFI is on from VONAGE” has box 316 selected as a suggestion to the user. If the user chooses to save this option, all future calls made using the native telecommunication module when a wireless access point is available will be diverted to the OTT telecommunication module. More generally, based on the stored user preference, all future outgoing calls having the same or similar calling parameters as the user preference will be diverted to the OTT telecommunication module. The method 400 ends at step 416.

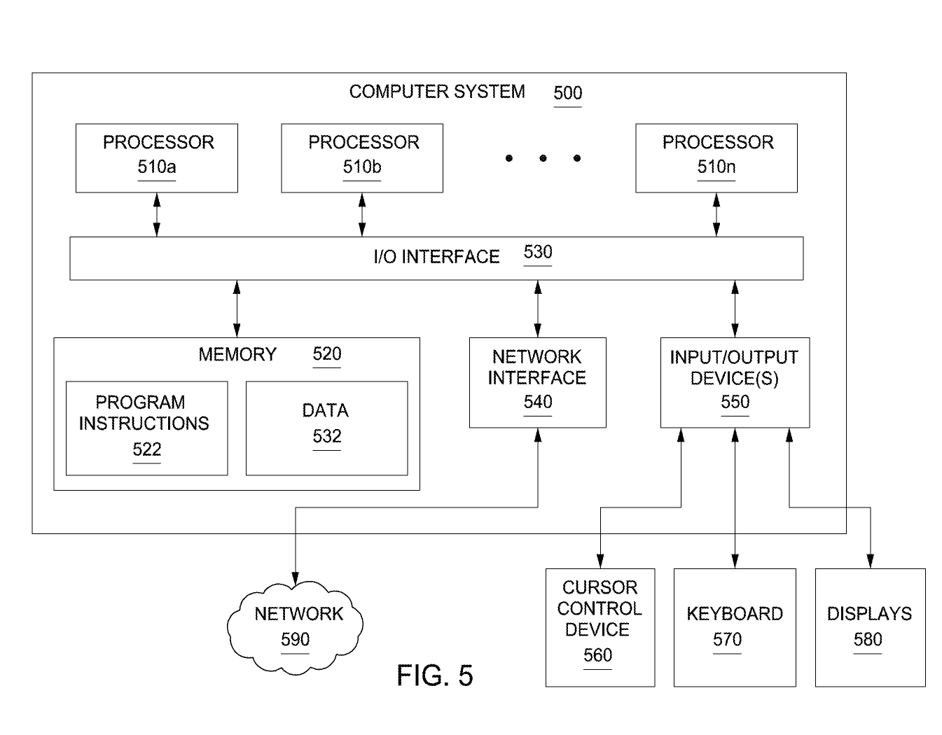

FIG. 5 depicts a computer system 500 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the method 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the operations described with respect to FIG. 2 and FIG. 3 and the methods illustrated by the flowchart of FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for providing selective call execution based on user preferences in a user communication device, comprising:
intercepting an outgoing call placed using a native telecommunication dialer of the user communication device; and
diverting the intercepted call to an over-the-top (OTT) telecommunication application based on a comparison of information associated with the intercepted call and one or more pre-selected user preferences for diverting calls to the OTT telecommunication application.

2. The method of claim 1, further comprising:
releasing the outgoing call to the native telecommunication dialer when criteria of one of a plurality of pre-selected user preferences for diverting calls to the OTT telecommunication application is not met; and
providing an option to select a user preference that would divert future outgoing calls having same or similar calling parameters as the outgoing call to the OTT telecommunication application.

3. The method of claim 1, wherein the OTT telecommunication application is a Voice over Internet Protocol (VoIP) telecommunication application.

4. The method of claim 1, wherein one of the pre-selected user preferences specifies that an outgoing call to a specified telephone number or contact is to be diverted to the OTT telecommunication application.

5. The method of claim 1, wherein one of the pre-selected user preferences specifies that an outgoing call to an international long-distance number is to be diverted to the OTT telecommunication application.

6. The method of claim 1, wherein one of the pre-selected user preferences specifies that an outgoing call is to be diverted to the OTT telecommunication application when a number of minutes logged using the native dialer exceeds a predefined threshold.

7. The method of claim 1, wherein one of the pre-selected user preferences specifies that an outgoing call is to be diverted to the OTT telecommunication application based on an availability of a wireless access point.

8. The method of claim 1, wherein one of the pre-selected user preferences specifies that an outgoing call is to be diverted to the OTT telecommunication application when the outgoing call is made from one of a specific location or a specific wireless access point.

9. A system for providing selective call execution based on user preferences in a user communication device, comprising:
a routing configuration module configured to receive and store user preferences for intercepting an outgoing call placed using a native telecommunication dialer of the user communication device and diverting the intercepted call to an over-the-top (OTT) telecommunication application based on a comparison of information associated with the intercepted call and one or more pre-selected user preferences for diverting calls to the OTT telecommunication application; and
a call-intercept module configured to intercept an outgoing call placed using a native telecommunication dialer.

10. The system of claim 9, wherein the call-intercept module is further configured to release the outgoing call to the native telecommunication dialer when criteria of one of a plurality of pre-selected user preferences for diverting calls to the OTT telecommunication application is not met; and
provide an option to select a user preference that would divert future outgoing calls having same or similar calling parameters as the outgoing call to the OTT telecommunication application.

11. The system of claim 9, wherein the OTT telecommunication application is a Voice over Internet Protocol (VoIP) telecommunication application.

12. The system of claim 9, wherein one of the pre-selected user preferences specifies that an outgoing call to a specified telephone number or contact is to be diverted to the OTT telecommunication application.

13. The system of claim 9, wherein one of the pre-selected user preferences specifies that an outgoing call to an international long-distance number is to be diverted to the OTT telecommunication application.

14. The system of claim 9, wherein one of the pre-selected user preferences specifies that an outgoing call is to be diverted to the OTT telecommunication application when a number of minutes logged using the native dialer exceed a predefined threshold.

15. The system of claim 9, wherein one of the pre-selected user preferences specifies that an outgoing call is to be diverted to the OTT telecommunication application based on an availability of a wireless access point.

16. The system of claim 9, wherein one of the pre-selected user preferences specifies that an outgoing call is to be diverted to the OTT telecommunication application when the outgoing call is made from one of a specific location or a specific wireless access point.

17. A non-transitory computer readable medium for storing computer instructions that, when executed by at least one processor causes the at least one processor to perform a method for providing selective call execution based on user preferences in a user communication device, comprising:
intercepting an outgoing call placed using a native telecommunication dialer of the user communication device; and
diverting the intercepted call to an over-the-top (OTT) telecommunication application based on a comparison of information associated with the intercepted call and one or more pre-selected user preferences for diverting calls to the OTT telecommunication application.

18. The computer readable medium of claim 17, further comprising:
releasing the outgoing call to the native telecommunication dialer when criteria of one of a plurality of pre-selected user preferences for diverting calls to the OTT telecommunication application is not met; and
providing an option to select a user preference that would divert future outgoing calls having same or similar calling parameters as the outgoing call to the OTT telecommunication application.

19. The computer readable medium of claim 17, wherein the OTT telecommunication application is a Voice over Internet Protocol (VoIP) telecommunication application.

20. The computer readable medium of claim 17, wherein the pre-selected user preferences specify that one of (i) an outgoing call to a specified telephone number or contact is to be diverted to the OTT telecommunication application, (ii) an outgoing call to an international long-distance number is to be diverted to the OTT telecommunication application (iii) an outgoing call is to be diverted to the OTT telecommunication application when a number of minutes logged using the native dialer exceed a predefined threshold (iv) an outgoing call is to be diverted to the OTT telecommunication application based on an availability of a wireless access point, or (v) an outgoing call is to be diverted to the OTT telecommunication application when the outgoing call is made from one of a specific location or a specific wireless access point.
